(19) United States
(12) Patent Application Publication
(10) Pub. No.: US 2007/0016462 A1
(43) Pub. Date: Jan. 18, 2007

(54) SYSTEM AND PROCESS FOR DISTRIBUTING PRODUCTS

(76) Inventors: Paul Atkinson, Poway, CA (US); Ronald S. Conero, San Diego, CA (US); Charles A. White, Oakland, CA (US)

Correspondence Address: WILLIAM J. KOLEGRAFF, 3119 TURNBERRY WAY, JAMUL, CA, 91935, US

(21) Appl. No.: 11/457,045

(22) Filed: Jul. 12, 2006

Related U.S. Application Data
(60) Provisional application No. 60/698,744, filed on Jul. 12, 2005.

(51) Int. Cl. G06Q 99/00; G05B 19/418; G06F 15/02; G06F 9/46

(52) U.S. Cl. 705/8; 705/1; 705/9

(57) ABSTRACT

A conditional access network is provide that generates and captures authenticated events. These authenticated events are securely generated responsive to communications between the network and processors, where the processors are embedded in associated targets or products. Events may be, for example, receiving targets into inventory, shipping targets to another entity, activating targets at a point of sale, or permanently disabling a defective target. These authenticated events are captured by the network, and used to support transactions. For example, the timely and trustworthy information derived from the authenticated events can be used to support financial, ownership, or regulatory transactions. In one use, the authenticated events enable a consignment business model where the distributor, retailer, and products all participate in the conditional access network. With the timely and accurate inventory, sales, and return information provided by the authenticated events, disputes over settlement are dramatically reduced.

### RELATED APPLICATIONS

This application claims priority to U.S. patent application No. 60/698,744, filed Jul. 12, 2005, and entitled “Methods for Controlling the Distribution of and Payment for Targets in a Distribution Network”, which is incorporated herein in its entirety.

### BACKGROUND

1. Field

The present invention relates to computer processes for distributing products. More particularly, the invention relates to automated processes that provide authenticated events that parties in a distribution system may rely on to support business transactions.

2. Description of Related Art

Products are typically made by a manufacturer, delivered to a retailer using distribution partners, and sold to consumers by a retailer. The manufacturer, distribution partners, and retailers use known computer accounting processes to account for movement of products between the entities, and use agreements and contracts to define when payments are due. Each time a product changes hands, there is a risk that the transfer will not be accurately accounted or reported. For example, a retailer may mis-count received product, or a distributor may leave a box of goods in a truck. In such a case, the manufacturer knows it shipped a particular number of products to a retailer, but the retailer reports a smaller quantity. Such discrepancies are difficult to reconcile, and may lead to a tumultuous business relationship, especially during settlement of the disputed transaction.

Worse, the lack of reliable and verified information may enable some partners to act to misappropriate goods. For example, a trucking company may claim it delivered a full load of goods, while only delivering a partial load. In another example, a retailer may claim that a quantity of goods were defective, when in fact the retailer sold the goods, and now requests that the manufacturer reimburse for those goods. The manufacturer could require the retailer to return the “defective” goods, but that may be more costly then giving the request reimbursement. With the several entities involved in the distribution process, there is ample opportunity for products to be misappropriated or lost in an accounting maze.

In a particular example, a manufacturer may entice retailers by offering a consignment sale arrangement. A consignment process generally allows a manufacture to ship products to a retailer, and then the retailer pays only for products that are sold, and after a period of time, the retailer returns any unsold products. This allows the retailer to avoid paying for inventory in advance, but places an additional risk on the manufacturer or consigning distributor. For example, the retailer may report that not all products were received into its inventory, or that some products were defective, when in fact they were sold. The retailer may also mis-report the timing of sales so to allow payments to be made at a time later then agreed to. Because of the ample opportunity to cheat in a consignment relationship, the use of consignment sales has been limited. Such a consignment relationship requires a high degree of trust, which is time-consuming, expensive, and difficult to establish. In such a way, consignment sales opportunities are risky to establish, and require much effort to monitor and enforce.

Accordingly, there exists a need for improved distribution processes, and in particular, improved consignment distribution systems.

### SUMMARY

Briefly, the present invention uses a conditional access network to generate and capture authenticated events. These authenticated events are securely generated responsive to communications between the network and processors, where the processors are attached to or embedded in associated targets or products. Events may be, for example, receiving targets into inventory, shipping targets to another entity, activating targets at a point of sale, or permanently disabling a defective target. These authenticated events are captured by the network, and used to support transactions. For example, the timely and trustworthy information derived from the authenticated events can be used to support financial, ownership, or regulatory transactions. In one use, the authenticated events enable a consignment business model where the distributor, retailer, and products all participate in the conditional access network. With the timely and accurate inventory, sales, and return information provided by the authenticated events, disputes over settlement are dramatically reduced.

The disclosed systems generally relate to methods, systems, products and business models for managing the distribution of products (i.e., targets) among parties in a distribution network. Such management is accomplished through the use of an embedded processor (EP) or other device associated with a target which provides authorized parties with conditional access to the target and denies access to the target by unauthorized parties. The existence of authenticated transactions can be used to reliably determine changes in ownership of a product and to determine the appropriate financial settlement for parties participating in the distribution of the product.

In one aspect, a method for providing secure and authenticated transaction events at a user's point of presence is provided. This method is performed with a communication device, such as a reader, and an authentication device, such as an embedded processor that operates within a conditional access network. The conditional access network may use a network operation center (NOC) to centralized command and control of target information. The present methods require a determination of whether a user is authorized to perform or participate in a specific authorized event, and whether an embedded processor is authorized to participate in the specific authorized event with a target.

In one embodiment of this method, an EP (embedded processor) first validates a requester of an authorized event by determining that the requestor is authorized to perform or participate in a specific authorized event. The requestor, such as a user of a target, sends an authorized transaction to the embedded processor, and the EP performs the action associated with the authenticated event. The embedded processor then sends a response to the requestor, and the requester transmits the response to a network operations center. The response can then be recorded in a database of the network operations center and provided to parties having an interest in the target or the authorized transaction, in particular trading parties such as a manufacturer, distributor, wholesaler, or retailer of the target. The authenticated event can be, for example, a return transaction, a request that an action be performed on a target, or a request that the target be disabled. Authentication can occur through the use of token pairs, a private key infrastructure certificate, or passwords, for example.

In another embodiment, the present methods comprise a method for performing financial settlements among parties involved in trading a target, based on authenticated events or on information derived from authenticated events, by correlating authenticated events to financial events and then using these financial events to determine financial settlement (transfer of funds) among trading parties. The settlement can involve, for example, the transfer of funds from a distributor to a product manufacturer; the transfer of funds from a product purchaser to a network operations center and then from the network operations center to trading partners; the transfer of funds from a product purchaser to a product wholesaler; or the transfer of funds from a product manufacturer to a distributor. The settlement can be performed as transactions occur or at regular intervals determined by time or target sales volumes. In an alternative embodiment, rather than transferring funds to settle a transaction, the present methods can be used to transfer ownership of a target among trading parties, based upon authenticated events or information derived from authenticated events. A network operations center preferably also maintains a supply chain database of parties involved in the distribution of products.

### BRIEF DESCRIPTION OF DRAWINGS

These and other features, aspects and advantages of the present invention will become better understood with regard to the following description, appended claims, and accompanying figures where:

FIG. 1 is a flowchart of a process for using authenticated transactions in accordance with the present invention.

FIG. 1A is a block diagram of a network system for providing information to support the methods and systems in accordance with the present invention.

FIG. 2 is a block diagram of a process for using authenticated transactions in accordance with the present invention.

FIG. 3 is a block diagram of a system for using authenticated transactions in accordance with the present invention.

FIG. 4 is a block diagram of a system for using authenticated transactions in accordance with the present invention.

FIG. 5 is a flow chart illustrating an embodiment that supports consignment sales in accordance with the present invention.

FIG. 6 is a flow chart illustrating an embodiment where an NOC provides integrated payment and settlement among parties in a trading network in accordance with the present invention.

FIG. 7 is a flow chart illustrating an authenticated return (AR) transaction in accordance with the present invention.

FIG. 8 is a flow chart illustrating an embodiment in which an activated target is returned to an authenticated return site in accordance with the present invention.

### DETAILED DESCRIPTION OF THE INVENTION

Detailed descriptions of examples of the invention are provided herein. It is to be understood, however, that the present invention may be exemplified in various forms. Therefore, the specific details disclosed herein are not to be interpreted as limiting, but rather as a representative basis for teaching one skilled in the art how to employ the present invention in virtually any detailed system, structure, or manner.

The ability to deny access to a feature of a target and to securely enable an authorized and authenticated party access to such feature can broaden the range of possible distribution channels for a product, and thereby increase sales opportunities. In particular, this ability enables consignment business models that are more efficient and effective than are possible today.

The consignment of targets through a supply chain requires the creation of a trusted relationship between a product manufacturer and distributors. The target manufacturer needs to establish certainty about target sale and return events in order to understand the revenue to expect from the distributor. This certainty is difficult to establish in many situations and results in constraints on the range of possible distributors available for a manufacturer to do business with, as well as in the need to invest in control processes and procedures to gain that certainty.

Controlled conditional access to targets provides such certainty with regard to the occurrence of events (authenticated events) and lessens or removes the need for a manufacturer to establish the types of trusted relationships that were heretofore necessary. Controlled conditional access to targets thereby enables the distribution of targets through channels that otherwise would not be established by a manufacturer. Such access also makes possible or economically feasible the distribution of targets in environments where security is an issue. For example, the distribution of optical media (e.g. CDs and DVDs) at retail locations frequently requires the isolation of targets and controlled access to such targets in order to minimize theft. Through the implementation of controlled conditional access to these targets, they can be displayed in a more favorable manner at existing retail locations (e.g., out from behind glass cabinets), because one or more valuable features of such targets will not be available if the targets are stolen or otherwise disposed of without authorization. Conditionally accessible targets can also be distributed through retail locations that do not otherwise have sufficient security in place to display such optical media or which, for reasons of logistics, do not have the ability to implement appropriate security measures. It is also possible to link financial settlements relating to the sale, return or destruction of targets among the participants in the supply chain to further broaden the range of possible retail locations to include those that do not have their own payment processing capability or for which the integration of the payment and settlement of a target is difficult.

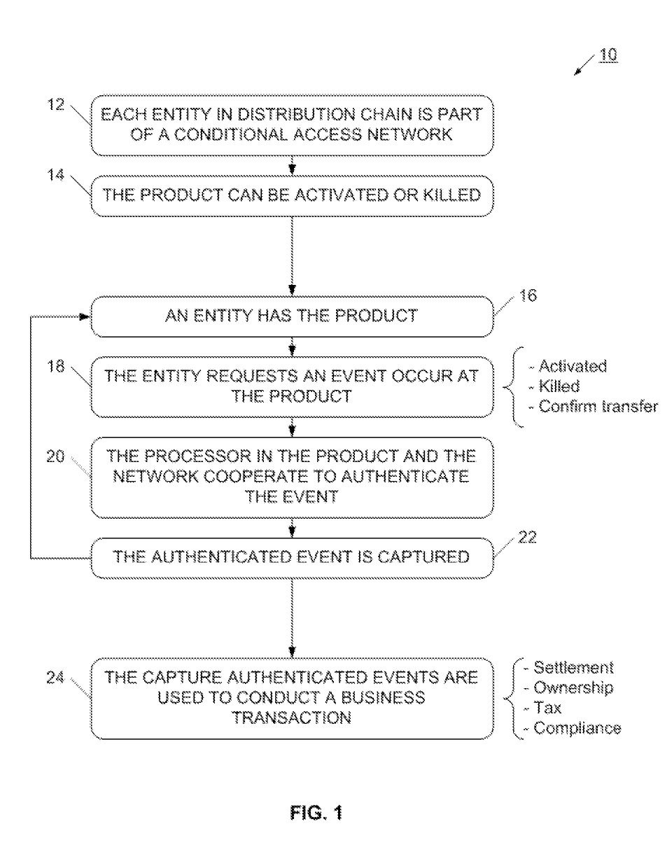

Referring now to FIG. 1, a process for distributing products is illustrated. Process 10 advantageously enables trading partners in a distribution process to confidently and accurately verify transactions, and thereby more effectively account and settle transactions. In this way, process 10 provides a substitute or alternative for building long-term trusted relationships. Accordingly, distribution processes may be enabled without the expense and long-term commitment of building relationships, thereby allowing greater flexibility in establishing distribution arrangements. In distribution process 10, each entity in the distribution chain is part of a conditional access network. This conditional access network has products that have been specially manufactured to participate in the network as shown in block 14. More particularly, the products may be disabled at the point of manufacture, tracked through the distribution chain, and then activated at the point-of-sale. Under certain conditions, the ability to activate the product may be disabled or killed, thereby making the product useless for its intended purpose.

The conditional access network has two important but separate aspects. First, only authorized entities are allowed to cause an action at the product, such as an activation or kill. Second, all transactions are authenticated, which means that the target provides confirmation that an authorized entity requested an action, and the action was actually performed. Since it is the processor associated with the product itself that is communicating the authenticated message, all parties can be confident that the authenticated transaction has been performed, and financial and accounting records may reliably use the authenticated event information.

In operation, the product is originally manufactured with an embedded processor or integrated circuit set to disable the usability of the product. Then, as each entity in the distribution chain receives product as shown in block 16, that entity may request an event occur at the product as shown in block 18. For example, the entity may request that the product be, activated, killed, or confirm a transfer between entities. A confirmation of transfer may be useful to confirm return of the product or change of ownership of the product. Provided the entity is authorized to have made the request, and the request is valid, then the embedded processor operates the action as shown in block 20. In performing the action, the processor cooperates with the network, and communicates to the network that an authenticated event or action has occurred. The authenticated event is then captured by the network as shown in block 22. From time to time, the captured authenticated events may them be used to conduct business transactions between trading partners as shown in block 24. For example, the authenticated events may be used to verify revenue events for settlement purposes, change of ownership, tax calculations, or to show compliance with regulations. Because the authenticated events and actions are confirmed by the product itself, and captured by the neutral third-party network, all parties can be confident that financial transactions may be based upon the captured information.

Prior to describing other transaction systems and methods, it may be useful to generally describe the radio frequency integrated circuit, and the conditional access network in which it operates.

### DESCRIPTION OF THE NETWORK SYSTEM

The method 10 described with reference to FIG. 1 has been described as operating on a conditional access network system. Referring now to FIG. 1A, an example of such a conditional access network system is illustrated. System 25 may operate, for example, in a retail environment, or may be part of a home based activation system. System 25 has target 26, which may be, for example, an optical disc such as a DVD, CD, gaming disc, HD DVD, or Blu-Ray DVD; the target may be an electronic device such as a portable music player, shaver, or drill; or the target may be a passport, driver's license, coupon, or other non-electronic good. It will be understood that target 26 may take other electronic or non-electronic forms. Target 26 has a utility 27, which is typically the primary usefulness for the target device. For example, if target 26 is a portable music player, then utility 27 is the ability to play music files. In another example, if target 26 is a DVD, then its primary utility 27 is to be read by an associated DVD player for presenting a movie or audio file to a user. Typically, utility 27 is the reason consumers are motivated to purchase or otherwise obtain target 26. Stated differently, if utility 27 were unavailable, and target 26 is not an attractive good for the consumer. In a similar way, the target would be unattractive for a thief or shoplifter. Further, by controlling a consumer's access to the utility of a product, a manufacturer is enabled to manage the rights to use the product. In this way, the manufacturer may set the conditions under which a consumer is able to use the physical product, and can even make the product forever unusable, thereby removing it from the stream of commerce. Importantly, this is all managed through a central network operations center, so does not require that the physical goods be returned to the manufacturer to be disabled.

Target 26 has a radio frequency integrated circuit 28. The integrated circuit 28 may be, for example, a tag attached to target 26, or may be integrally formed with other target circuitry or structures. Integrated circuit 28 couples to utility 27, and may selectively activate or deactivate the utility for target 26. For example, a DVD may initially be set such that it is unplayable in most DVD players, but upon an authorized sale, may have its utility activated. In this way, the DVD is unattractive to a thief or shoplifter while the DVD is in the distribution chain, but may be advantageously used by an authorized consumer. In another example, an electronic device has its power circuit disabled at the time of manufacture. The electronic device may then be moved through the distribution chain with a substantially reduced threat of theft. Since the electronic device would be unusable by any potential thief or shoplifter, it is far less likely that anyone will steal or otherwise misappropriate the device. However, at the point-of-sale and upon consummation of an authorized transaction, the power circuit for the electronic device may be activated. In this way, the authorized consumer may normally use the electronic device for its intended purpose.

An enlarged view of integrated circuit 28 shows that integrated circuit 28 has a memory, logic, and a radio frequency portion coupled to antenna 31. Upon receiving appropriate codes or commands via antenna 31, the integrated circuit may cause switch 33 to change states. More particularly, the RF section may receive codes or commands that the logic compares to commands or codes stored in memory. If the received codes match codes secretly stored in memory, then the integrated circuit may determine that an authorized code has been received. This command may, for example, cause the utility 27 to activate, or may cause the utility 27 to deactivate. In one state, switch 33 causes the utility 27 to be unavailable, and in another state causes the utility 27 to be fully available. It will be appreciated that switch 33 may be constructed with more than two states. However, for ease of explanation, switch 33 will be described as having only a deactivated state and an activated state.

It will be understood that switch 33 may take several forms. For example, switch 33 may be an electrochromic material that changes optical characteristics responsive to the application of a voltage. In another example, switch 33 may be fuse, anti-fuse, or other circuit device that is capable of changing electronic states. In yet another example, switch 33 may be a memory logic state, or a circuit device that has a voltage that may be sensed and understood as a logic value. It will also be understood that in some cases switch 33 main be persistently transitioned from a first state to a second state, and in other cases switch 33 may be reversible.

At time of manufacture, IC 28 is typically set to disable utility 27 for target 26. In this way, target 26 is an unattractive theft target, as it is in an unusable or disabled state. At the point-of-sale, which may be a point-of-sale terminal in a retail establishment, a kiosk, or a home activation site, target 26 is placed proximate a reader 35. Reader 35 has an RF antenna 37 and RF transceiver for communicating with IC 28. When positioned proximate reader 35, IC 28 passes identifying information to reader 35, which then communicates the identifying information through a network connection 39 to an operations center 41. The operations center 41 generates or retrieves an activation or authorization code specific for target 26. The activation or authorization code is transmitted back to reader 35 and then communicated to target 26. Provided a proper code is received, the logic causes switch 33 to change state, and activate the utility 27 for target 26. In this way, the target has no or reduced utility through the distribution chain, but is efficiently activated at a point-of-sale.

Although the above description describes an activation process, in a more general case, the IC may be used to selectively make a range of functions available or unavailable, and may make some of these functions only temporarily available. In this sense, the IC and network processes are used to affect the utility of the target. The target with controllable utility may be an electronic device, or alternatively, may be a tangible media, such as an optical disc. The controlled target has a change effecting device that is set to a first state, which allows the target to operate according to a first utility. The controlled target also has a receiver for receiving an authorization key, and logic, which, responsive to the authorization key, selectively changes the change effecting device to a second state. When the change effecting device is in the second state, the target may operate according to a second utility. In one example, the controlled target has a restricted access key that was stored during manufacture, and the restricted access key is used by the logic in changing the state of the change effecting device. To change the utility of the controlled target, the controlled target is placed proximate to an activation device. The activation device may read an accessible identifier from the controlled target, and retrieve or generate an authorization key that is associated with the target. The activation device may cooperate with a network operation center or other entity to retrieve the authorization key, and to obtain approval to change the utility of the controlled target. If approved, the activation device may then send the authorization code to the controlled target.

A distribution control system is provided to support the controlled and selective changing of utility for a target. The target with controlled utility may be an electronic device, or alternatively, may be a tangible media, such as an optical disc. The distribution control system has a target with a change effecting device and a restricted access key. An activation device retrieves or generates an authorization key, and sends the authorization key to the target. The authorization key may be sent to the target wirelessly, for example, using a radio frequency signal. The target has logic that uses the restricted access key and the authorization key to change the utility of the target. In one example, the activation device retrieves the authorization key from a network operation center (NOC) by sending a target identifier to the NOC, and the NOC retrieves the authorization key for the identified target. The activation device may also connect to other systems for obtaining approval to change the utility of the target. For example, the authorization key may be sent to the target upon receiving payment, password, or other confirmation.

In a specific example of the distribution control system, a target is manufactured with a change effecting device set to compromise the utility of the target. In this way, the compromised target would be nearly useless to a thief, and therefore would be less likely to be a target of theft. The manufacturer has also stored an identifier and a restricted access key with the target. The manufacturer also stores the accessible identifier and its associated key for later retrieval by a party authorized to restore the utility to the target. In one example, the identifiers and keys are stored at a network operation center (NOC). The compromised target may be moved and transferred through the distribution chain with a substantially reduced threat of theft. When a consumer decides to purchase the target, the target is passed proximally to an activation device. Its accessible ID is read by activation device, and using a network connection to the NOC, sends the accessible ID. The NOC retrieves the authorization key for the target. Additional approvals may be obtained, for example, confirmation of payment, identification, password, or age. When approved, the activation device transmits the authorization key to the target, typically using a wireless communication. The target receives the authorization key, and using its logic, compares the authorization key to its stored restricted access key. If the keys match, then the target uses an activation power source to switch the state of the change effecting device. Then, the target will have full utility available to consumer.

The systems, processes, networks and devices for providing an RF activatable product are fully set out in the following U.S. Patent application, which is incorporated herein by reference as if set forth in its entirety:
1. U.S. patent application Ser. No. 11/295,867, filed Dec. 7, 2005, and entitled “Device and Method for Selectively Activating a Target”.

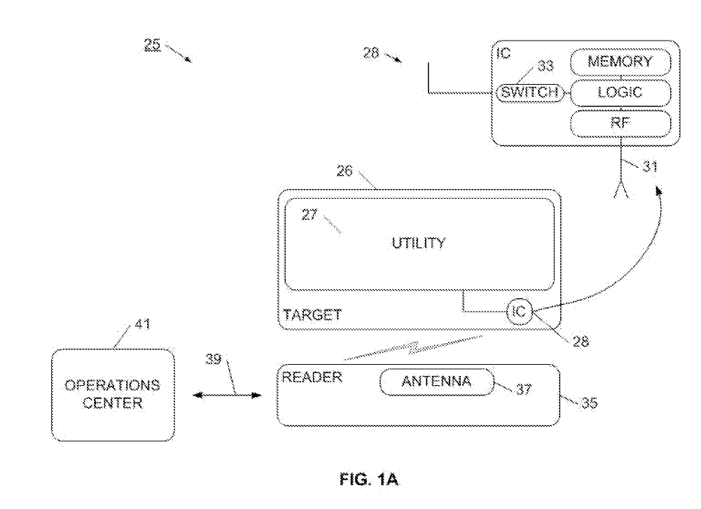

Referring now to FIG. 2, a system 50 for disturbing products is illustrated. System 50 has a conditional access network as described with reference to FIG. 1A. Product 52 has an embedded processor and is set to disable the product, typically by the manufacturer 54. When the product is disabled, or when the product is shipped from the manufacturer, the manufacturer may scan product 52 with a reader 56. The reader 56 requests an event for the product 52, such as its identification number to confirm transfer, or requests that the product be disabled. The product then cooperates with the conditional access network to authenticate the event, and the event is captured 62. The product is then transported to a first distributor 66, which may be, for example, a shipping company. The shipping company may request an event from the product using its reader 68. Again the product cooperates with the conditional access network to authenticate the transaction, and the event is captured 62. The product may then be moved through the distribution chain to a second distributor 74, which also requests an event occur at the product. Provided that the distributor is authorized, the conditional access network and embedded processor cooperate to authenticate the event, and the authenticated event is captured 62. Finally, the product is received at retailer 83. At the point-of-sale, the point-of-sale reader 85 requests that the product be activated. The embedded processor in the product cooperates with the conditional access network to authenticate the activation event, which is recorded as a captured authenticated event 62. In this way, each action performed on the product 52 was done by authorized entity, and was authenticated by secure communication processes between the product's embedded processor and the conditional access network. Accordingly, accurate reports may be made 87, and financial settlements 89 may be confidently paid. These reports and settlements may be between any of the distribution partners, or may involve third parties 91. For example, a bank may own an interest in some products, and when sold, the bank may automatically be credited the appropriate revenue.

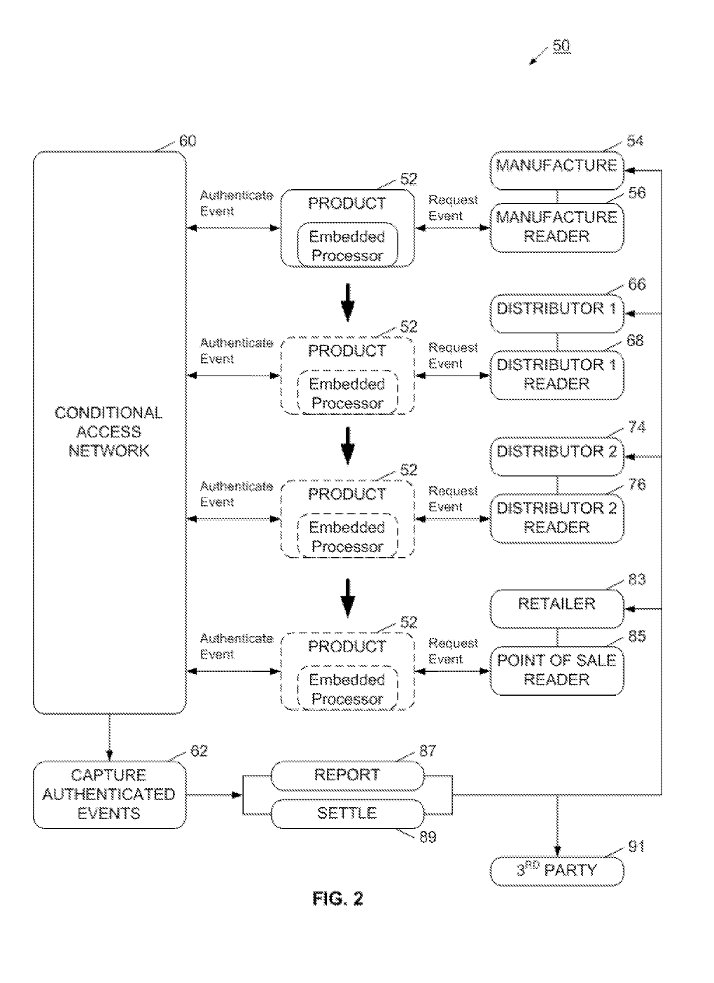

Referring now to FIG. 3, a process for distribution is illustrated. System 100 has a manufacturer 104, distributor 108, distributor 115, and retailer 121 that cooperate to bring a product through the distribution chain. The product has an embedded processor that may conditionally activate, disable, or report transactions regarding the target. In performing these actions and generating authentication messages, the processor communicates with a conditional access network. Typically, the embedded processor communicates through an RF communication channel, such as an RFID, or near field communication frequency. At each point in the distribution process, the entity may request actions or events occur at the target through the action of the embedded processor. For example, these events or actions may include activating, deactivating, or tracking the location of an embedded processor attached to a target or product. Provided the entity is authorized to make the request, and the embedded processor successfully completes the event or action, then the network captures an authenticated event as shown in blocks 106, 111, 117, and 123. The conditional access network 102 may thereby build a database or other file indicative of all authenticated events occurring for every product in the network. This authenticated event information may specifically provide physical location and distributor information as shown in block 127. For example, the conditional access network may know which distributor is in control of each product at any time.

Further, the conditional access network is aware of specific product status 129. Product status 129 may include being activated, being disabled, or being in a partially activated state. This location and status information may then be used to generate reports 131 and to make financial settlements 133. These reports and settlements may be made by the operator of the conditional access network or may be made between individual trading partners. For example, the operator of the conditional access network may provide a service for settlement between trading partners. Because the conditional access network operator is a trusted third party for all distribution entities, it is uniquely positioned to prepare auditable reports and perform direct financial transactions. Also, the reports may be used to drive settlement transactions between parties. Since both parties receive the same authenticated event information, and the event information is trustworthy, the process of settlement is simplified. Of course, the trading parties may also use a third-party 135 for settlement. For example, the distribution partners may use an escrow or other service for managing financial transactions.

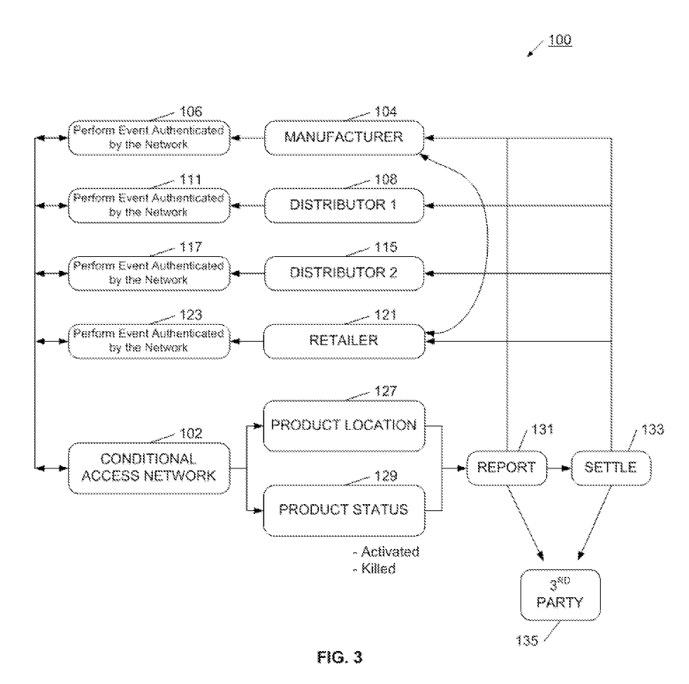

Referring now to FIG. 4, a consignment process 150 is illustrated. A consignment process generally allows a manufacture to ship products to a retailer, and then the retailer pays only for products that are sold, and returns any unsold products. This allows the retailer to avoid paying for inventory in advance, but places an additional risk on the manufacturer or consigning distributor. Typically, such a consignment relationship requires a high degree of trust, which is time-consuming, expensive, and difficult to establish. In such a way, consignment sales opportunities have been limited in the past. However, when the manufacturer, retailer, and other distribution partners are part of a conditional access network, then the conditional access network may substitute for a long-term trusted relationship. Accordingly, the manufacturer may contract with the retailer to consign products as shown in 152. The products are disabled at the point of manufacture, and have an embedded processor that is able to authenticate events as the product moves through the distribution chain. For example, the embedded processor and product may be tracked using authenticated events as the product moves through the distribution chain as shown in block 154. In this way, the manufacturer may confirm that the retailer has received the products as shown in block 156. Because the conditional access network tracks products down to the item level, the manufacturer knows each and every item that has been consigned to the retailer, and can confirm that those items are in the retailer's inventory 165.

As the retailer sells consigned products, the products are activated using the conditional access network. In this way, the activations are authenticated events 167 that are then captured through the conditional access network. As products are sold and activated, the retailer may be charged or debited for the sale as shown in block 169. In some cases, a product may need to be disabled from ever being activated, and thereby an authenticated killed is confirmed as shown in block 171. Products may need to be disabled if they are defective, or if they represent overstock inventory and it is more efficient to disable the product then package it and ship it back to the manufacture. In this way, even though the products are not received back at the manufacture, the manufacturer can confirm the products have been removed from the stream of commerce. Accordingly, upon receiving confirmation of the authenticated kill event, the manufacturer can credit the retailer a shown in block 173. Also, if consumers return products to the retailer or a third-party, the return event may be tracked as shown in block 175. Again, because the transaction is confirmed through an authenticated event, the manufacturer is confident in crediting the retailer as shown in block 177.

The manufacture has immediate information as to the inventory 165 held by the retailer. For each activation 167, the inventory is reduced; for each authenticated kill, the inventory is reduced; and for returns, the inventory may be increased. However, in some cases a return may be in condition that it is more efficient to kill the product then return it to the retail shelf. Relying on the inventory and authenticated event information, the manufacturer and retailer can effectively, confidently, and efficiently reach settlement 181. Further, detailed reports 186 can support all settlement transactions. In one example, the operator of the conditional access network assists in fund transfers 189, or fund transfers may be handled by third parties, or may be made directly between the retailer and the manufacturer. Even though the consignment model 150 was discussed relative to a retailer and manufacturer, it will be understood that a consignment model may have many other applications.

The use of targets associated with EPs (embedded processors) as described herein allows a target manufacturer to broaden the range of distribution locations available for its targets, and allows distributors to broaden the range of products that they distribute. Both manufacturers and distributors can be provided with a more secure environment for distributing products through the use of conditionally accessed targets. The reduction in risk associated with a transaction due to the distribution of conditionally accessed targets can lead to improved profitability or a reduced cost associated with the transaction.

Increased security is provided by the present methods by the use of authenticated events to control of a feature of a conditionally accessed target, in particular an attribute which confers utility or value. Authenticated events occur on a secure conditional access network, as described above. In authenticated event transactions, an action is taken by an EP once the EP has determined that it has received a valid request to perform an action, such as activating a target as described above. Authenticated events thus provide a more secure method of ensuring that the benefit of a target (i.e., a feature having value to an end user) accrues only to parties that have obtained the rights to the target's benefits through authorized channels (e.g., by purchasing the target).

Authenticated events that are particularly relevant to managing settlement among parties in a distribution network include target activation, authenticated return, authenticated deactivation and authenticated kill transactions. The authenticated return transaction provides a means for ensuring that a target was returned to an authorized return site. The authenticated deactivation transaction denies access to some benefit of the target in a manner that allows the benefit to be restored. The authenticated kill transaction permanently denies (or in some instances guarantees) access to some benefit of the target. The choice of authenticated events to have implemented by an embedded processor can vary by target based upon the requirements of the target manufacturer and the distribution network used.

The use of authenticated event s facilitates the consignment of targets to distributors. Rather than rely on information provided by a distributor, such as information regarding the sale or return of targets, a manufacturer can refer to authenticated event reports generated by a network operation center as described herein, and such reports can be used to direct financial settlements between all parties.

In addition, because of the security provided by the use of authenticated events, it is possible to construct a more accurate and secure financial settlement network. In one embodiment, consignment sales are authenticated as an authenticated event. In this embodiment, the movement of funds from a distributor or retailer to the manufacturer or wholesaler of a target is directed by and contingent on information derived from authenticated event transaction activity. The network operation center acts as a trusted third party in the transaction in this method, and in one embodiment determines when funds should be transferred based on information concerning authenticated events.

In another embodiment, a network operation center can provide integrated payment processing services. Purchasers of the targets can pay the network operation center, and the network operation center can then provide funds to all of the parties in the distribution process (manufacturer, distributor, wholesaler, or retailer) according to a pre-agreed arrangement or formula, such as on a periodic basis. In yet another embodiment, payment is made directly to the target manufacturer or wholesaler, and the recipient of the payment provides payment relating to the sale of the target to distributors or retailers based on information provided by the network operation center. Because the authenticated events can be validated by the network operation center, all parties involved in using the present methods are provided assurance that the compensated events accurately reflect real transactions. These methods also provide flexibility in pricing, such as allowing for different prices for goods provided to different distributors or for varying the compensation paid to distributors based on the time or volume of authenticated events sold by such distributors.

Representative examples of these embodiments are described below. In all embodiments, a secure network among the trading partners is established, such as through the use of systems using standard private key infrastructure (“PKI”). Subsequent to this, authenticated event transactions are conducted.

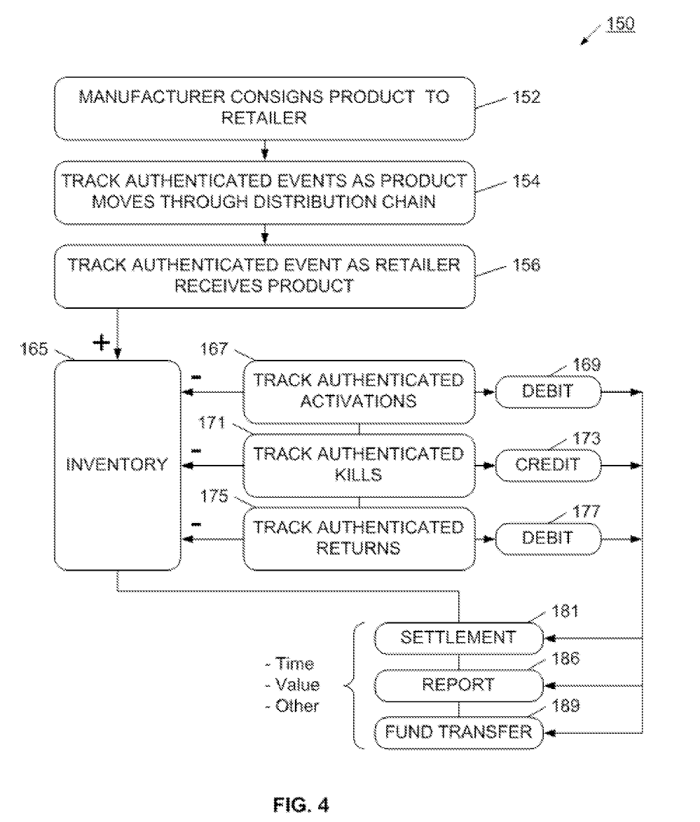

The embodiment of the present system and method 200 detailed in FIG. 5 supports traditional consignment sales. Either on a transaction per transaction basis or in the form of consolidated summaries provided on a periodic basis, authenticated event transactions are communicated to the target manufacturer or wholesaler. Information from these transactions is used by the target manufacturer, or by the network operation center on behalf of the target manufacturer, to construct a request for funds from the distributor to the target manufacturer. The target distributor settles with the target manufacturer or wholesaler based in whole or in part on this settlement report. In addition, the ownership of or the title for the target can be transferred among parties based on the financial settlement, or such transfer can be independent of the financial settlement.

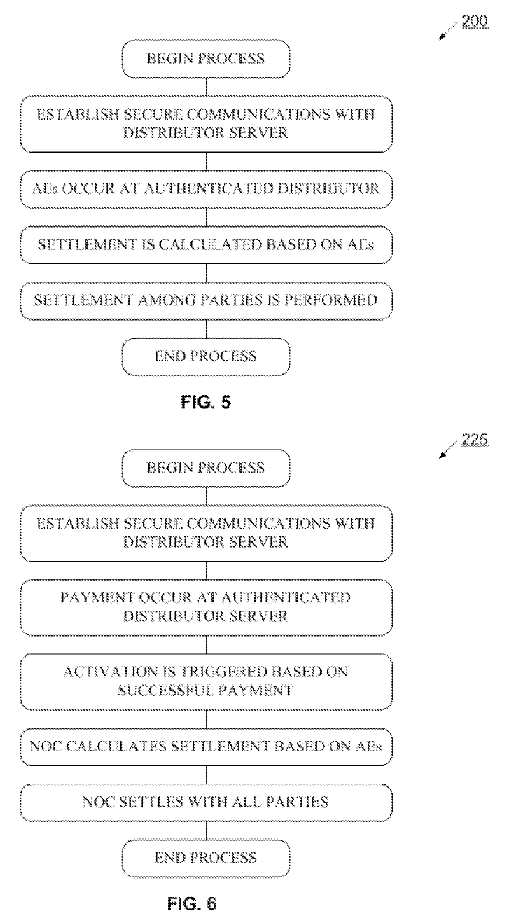

In another embodiment 225, a network operation center provides integrated payment and settlement among parties in the trading network. This process is detailed in FIG. 6. In this embodiment, the network operation center provides direct payment processing support at the point of sale and is the counterparty to the purchase transaction. In this case, an activation event would be triggered upon the successful completion of a payment purchase transaction. Financial instruments which can be used by the purchaser in this method can include but are not limited to credit or debit cards. The network operation center would then settle with the target manufacturer and the target distributor based upon the authenticated event transaction records.

In a further embodiment, a purchase transaction between a purchaser and target manufacturer or wholesaler is supported. In this embodiment, the distributor would be provided with an authenticated event transaction report or information derived from an authenticated event transaction report by the network operation center. This report would then be presented to the target manufacturer or wholesaler and used as a basis for funding.

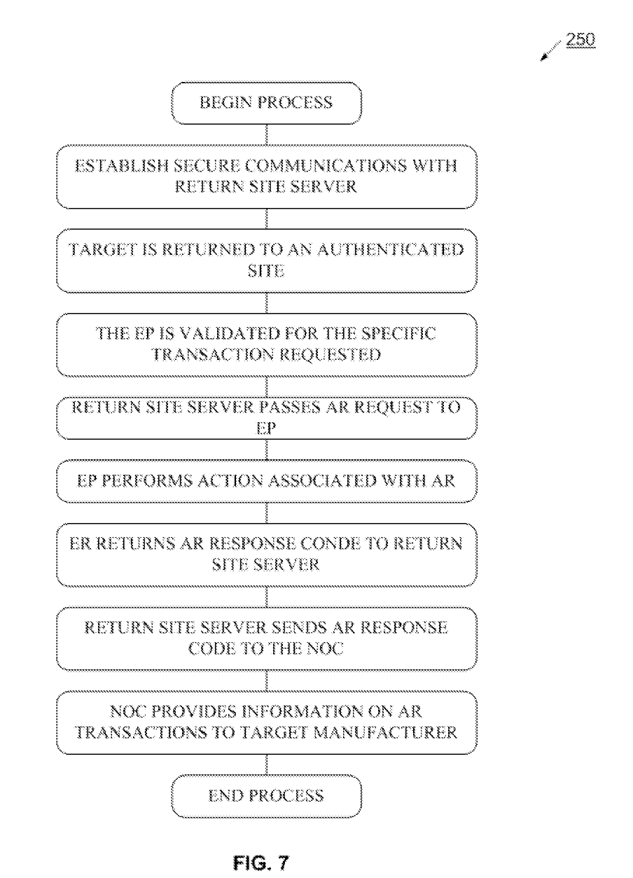

The following detailed description of authenticated return (AR) transaction types exemplifies the present methods, but other transaction types can be substituted in place of an authenticated return transaction. FIG. 7 details one embodiment 250 of an authenticated return transaction. In this embodiment, the activated target is returned to an authenticated return site. The server at the return site validates that the embedded processor is capable of processing a specific authenticated return request. If it is, the return server passes the specific authenticated return request to the embedded processor. The embedded processor initiates the action at the target and responds to the return site server with a valid authenticated return token. The authenticated return token is then passed to a network operations center and the network operation center logs the authenticated return token for subsequent communication with a target manufacturer or distributor. In this embodiment, the embedded processor does not validate the requester of the authenticated return transaction.

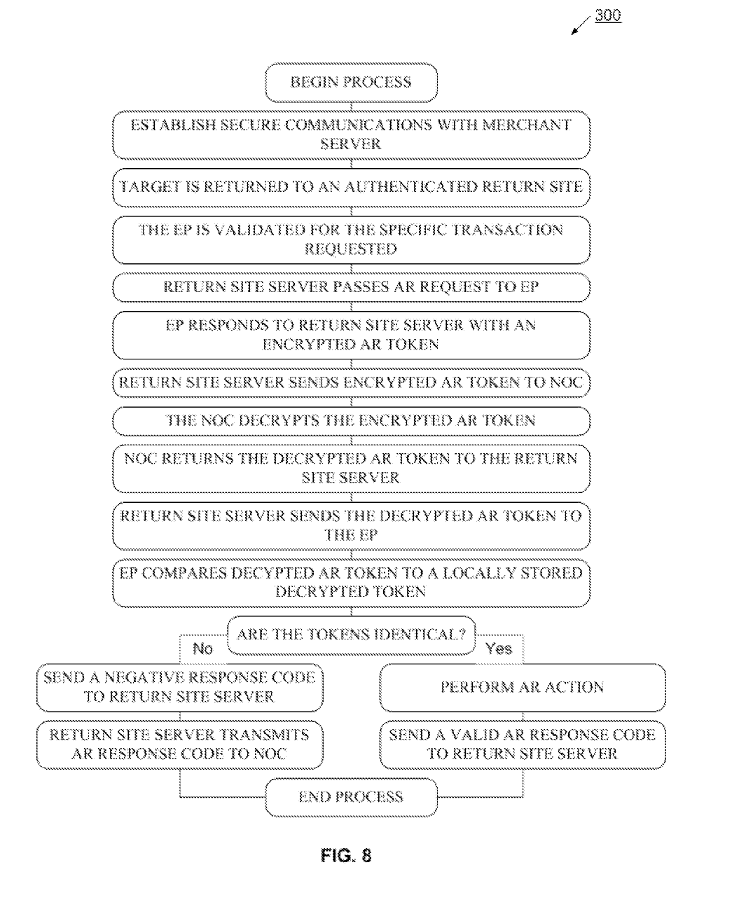

In another embodiment 300, detailed in FIG. 8, the activated target is returned to an authenticated return site. The server at the return site validates that the embedded processor is capable of processing a specific authenticated return request. If it is, the return server passes the specific authenticated return request to the embedded processor. The embedded processor responds with an encrypted authenticated return token to the return site server. The return site server passes the authenticated return token to a network operation center. The network operation center decrypts the authenticated return token and passes the decrypted version of the authenticated return token back to the return server. The return site server then passes the decrypted authenticated return token to the embedded processor. The embedded processor compares the authenticated return token to the decrypted version of the authenticated return token that was passed by the return site server, and if it is the same, the embedded processor initiates the appropriate action (e.g., nothing, temporarily activating or deactivating a feature of the target, or permanently activating or deactivating a feature).

Optionally, the embedded processor can respond to the return site server with a valid authenticated return token that had been loaded in the embedded processor. This valid authenticated return token is then returned to the network operation center for subsequent communication to the product manufacturer or wholesaler. This valid authenticated return token allows the network operation center to validate to the product manufacturer or wholesaler that an authenticated return transaction has occurred.

The use of an authenticated kill transaction in the manner described above can also provide great value throughout the supply chain. This is particularly the case in the optical media market. Today the cost of processing, returns for targets like optical media is high and it is incurred primarily so that the manufacturer or content owner can be assured that the target was indeed returned and not surreptitiously resold. The ability to authenticate a kill transaction, and thus be assured that a product has been killed and is no longer of value, eliminates the requirement for the target manufacturer to trust the procedures and systems of the distributor or retailer. This represents a more secure solution for sale, particularly by consignment, and opens up channels of distribution that were not previously possible.

Providing for Secure Activation

To provide the authenticated event information used in the disclosed distribution processes and systems, a supporting conditional access network is used. An integrated circuit is attached to a target such as an optical disc or electronic device. The integrated circuit has an RF transceiver that is capable of establishing communication with an associated reading device. The integrated circuit also has a hidden memory, which can not be read externally, and a user memory. The hidden memory stores an authentication message, while the user memory stores readable authentication information. The hidden authentication message and the authentication information are related through a cryptographic process. However, even though the integrated circuit benefits from the cryptographic security, the integrated circuit only operates relatively simple logic operations. In this way, a highly secure transaction is enabled without requiring significant processing power or time at the integrated circuit. When the integrated circuit is placed near the reader, the reader reads the authentication information, and with the cooperation of a network operation center, uses the authentication information to derive an activation code. The reader passes the activation code to the integrated circuit, which compares the activation code to its hidden activation message. If they have a proper relationship, the communication has been authenticated, and the integrated circuit proceeds to perform an action.

In one example, a random plaintext number is stored as the hidden authentication message, and the user memory has authentication information that includes an identifier, as well as an encrypted version of the plaintext number. When the integrated circuit is placed near a reader, the reader reads the authentication information, which is sent to a network operation center. The network operation center uses the identification information to retrieve a decryption key, and uses the key to decrypt the encrypted message to derive the plaintext number. The plaintext number is sent to the reader, which communicates it to the integrated circuit. The integrated circuit does a simple logical compare between the received number and the hidden number, and if they match, the integrated circuit proceeds to perform an action. The action may be, for example, activating or deactivating the product the circuit is attached to. The hidden authentication message and the authentication information are related through a cryptographic process. In this example, the integrated circuit benefits from the cryptographic security, even though the integrated circuit only operates a relatively simple logic operation. In this way, a highly secure transaction is enabled without requiring significant processing power or time at the integrated circuit.

In another example, an authentication code is stored as the hidden authentication message, and the user memory has authentication information that includes identifiers, as well as a public key that can be used to recreate the authentication code. When the integrated circuit is placed near a reader, the reader reads the authentication information, which is sent to a network operation center. The network operation center uses the identification information to retrieve a private key, and uses the public key, private key and other authentication information generate the authentication code. The authentication code is sent to the reader, which communicates it to the integrated circuit. The integrated circuit does a simple logical compare between the received code and the hidden code, and if they match, the integrated circuit proceeds to perform an action. The action may be, for example, activating or deactivating the product it is attached to. The hidden authentication message and the authentication information are related through a cryptographic process. In this example, the integrated circuit benefits from the cryptographic security, even though the integrated circuit only operates a relatively simple logic operation. In this way, a highly secure transaction is enabled without requiring significant processing power or time at the integrated circuit.

In yet another example, the present invention discloses a cryptographic process. Two pairs of public/private keys are generated in such a way that a combination of the first private key and the second public key is equivalent to the combination of the first public key with the second private key. The key combinations, when combined with additional meaningful information, produce a limited set of authentication messages. The process provides a highly secure method of authentication requiring minimal computation and power at the embedded processor.

Advantageously, the conditional access network enables a highly secure and authenticated transaction, even when the authorizing circuit is operating in a low-power, low processing capability environment. This means that an RFID tag or other RF-enabled integrated circuit may be used to communicate sensitive information, and become an integral part of a secure transaction process. This enables an RF-enabled circuit to perform secured actions, thereby allowing manufacturers to enforce distribution and use rules

The systems, processes, and devices for providing a secure activation network are fully set out in the following U.S. Patent applications, all of which are incorporated herein by reference as if set forth in their entirety:
1. U.S. patent application Ser. No. 11/456,037, filed Jul. 6, 2006, and entitled “Device and System for Authenticating and Securing Transactions Using RF Communication”;
2. U.S. patent application Ser. No. 11/456,040, filed Jul. 6, 2006, and entitled “Method for Authenticating and Securing Transactions Using RF Communication”;
3. U.S. patent application Ser. No. 11/456,043, filed Jul. 6, 2006, and entitled “Device and Method for Authenticating and Securing Transactions Using RF Communication:’ and
4. U.S. patent application Ser. No. 11/456,046, filed Jul. 6, 2006, and entitled “System and Method for Loading an Embedded Device to Authenticate and Secure Transactions.
   Providing for Permanent Deactivation

To provide the authenticated event information used in the disclosed distribution processes and systems, supporting deactivation devices and process are used. The deactivation systems have an integrated circuit device attached to a target. In one example, the integrated circuit device is a tag attached to or integrated with a product such as an electronic device or optical disc. In another example, the integrated circuit device may be integrated into the product's circuitry. The integrated circuit is controllable to effect an action at the target, such as activating or deactivating the usefulness of the product. The integrated circuit has a logic and memory section connected to an antenna for receiving communications from an associated reader or scanner. The integrated circuit also has a component constructed to transition from a first state to a permanent second state. For example, the component may be a fuse, a partial fuse, or an anti-fuse. The integrated circuit also stores a hidden secret kill code, and upon receiving a matching kill code from the reader, permanently transitions the component to its second state. When the component is in the permanent second state, the integrated circuit is incapable of effecting the action on the target. In this way, the integrated circuits ability to affect the target may be permanently disabled. The integrated circuit may also verify its function is disabled, and report a kill confirmation to the reader.

In one example, the integrated circuit is attached to an optical disc such as a DVD. The integrated circuit couples to an RF antenna for receiving data and power. The integrated circuit also has output ports connected to an electrochromic device, with the electrochromic device positioned over some important data on the disc. The optical disc is initially shipped with the electrochromic material in a darkened state, such that the DVD will not operate in an associated DVD player. If properly authorized, the integrated circuit is capable of transitioning the electrochromic material to a relatively transparent state, such that it activates the usefulness of the DVD so that it may be played. However, in some cases it may be desirable to cause the DVD to be permanently unplayable by disabling the ability of the integrated circuit to effect a change in the electrochromic material. Accordingly, the integrated circuit has a secret kill code in a write-once memory location. Upon receiving a matching kill code through the RF communication path, the integrated circuit causes a component to permanently transition to a second state. This component may be, for example, a fuse, a partial fuse, an anti-fuse, or a logic state. Upon transitioning the component, the integrated circuit is incapable of transitioning the electrochromic material to its transparent state. In this way, integrated circuit has been disabled from ever activating the DVD disc. The integrated circuit may also verify its ability to activate the disc is disabled, and report a kill confirmation to the reader. In this way, the retailer and manufacturer may be confident that the DVD has been permanently removed from the stream of commerce.

Advantageously, the kill process confidently and controllably allows products to be permanently disabled. In this way, manufacturers are enabled to more fully control the distribution of their products, and be assured that specific goods have been removed from the stream of commerce.

The systems, processes, and devices for permanently disabling the target from being activated are fully set out in the following U.S. Patent application, which is incorporated herein by reference as if set forth in its entirety:
1. U.S. patent application Ser. No. 11/456,680, filed Jul. 11, 2006, and entitled “A Radio Frequency Activated Integrated Circuit and method of Disabling the Same”.

While particular preferred and alternative embodiments of the present intention have been disclosed, it will be appreciated that many various modifications and extensions of the above described technology may be implemented using the teaching of this invention. All such modifications and extensions are intended to be included within the true spirit and scope of the appended claims.

What is claimed is:

1. A consignment process, comprising:
providing a plurality of target items, each item having an associated embedded processor for communicating with a conditional access network;
receiving information that at least some of the embedded processors cooperated with the network to generate authenticated events indicating their associated targets were accepted into an inventory;
receiving information that at least some of the embedded processors cooperated with the conditional access network to activate their respective targets in the inventory; and
conducting a business transaction according to the number of targets activated from inventory.

2. The consignment process according to claim 1, further including the steps of:
receiving information that at least some of the embedded processors cooperated with the conditional access network to permanently disable their respective targets in the inventory; and
adjusting the business transaction according to the number of targets permanently disabled.

3. The consignment process according to claim 1, further including the steps of:
receiving information that at least some of the embedded processors cooperated with the conditional access network to have control passed from inventory to another distribution party; and
adjusting the business transaction according to the number of targets transferred out of inventory.

4. The consignment process according to claim 1, further including the steps of:
receiving information that at least some of the embedded processors cooperated with the conditional access network to be returned after being activated; and
adjusting the business transaction according to the number of targets returned.

5. The consignment process according to claim 1, wherein the target is an optical disc or an electronic product.

6. The consignment process according to claim 1, wherein the business transaction is a settlement transaction and comprises automatic fund transfer.

7. The consignment process according to claim 1, wherein the business transaction comprises automatic report generation.

8. The consignment process according to claim 1, wherein the business transaction is brokered by the conditional access network.

9. The consignment process according to claim 1, wherein the business transaction is brokered by a third party.

10. A process for distributing products, comprising:
generating an authenticated deactivation event for each item of product deactivated;
generating an authenticated distributor event for each item of product that moves from one authorized distribution entity to another authorized distribution entity;
generating an authenticated activation event for each item of product that is activated; and
using the authenticated events to conduct a business transaction.

11. The process for distributing according to claim 10, wherein the manufacturer deactivates each item during manufacture.

12. The process for distributing according to claim 10, wherein a distribution party deactivates each item.

13. The process for distributing according to claim 10, further including the steps of:
generating an authenticated return event for each item of product that is returned to an authorized return entity; and
adjusting the business transaction according to the returned items.

14. The process for distributing according to claim 10, further including the steps of:
generating an authenticated kill event for each item of product that is permanently disabled by an authorized entity; and
adjusting the business transaction according to the disabled items.

15. The process for distributing according to claim 10, wherein generating each authenticated event comprises having an embedded processor that is associated with an item communicate with a conditional access network.

16. The process for distributing according to claim 15, wherein the conditional access network captures all the authenticated events.

17. The process for distributing according to claim 15, wherein the conditional access network automatically conducts the business transaction.

18. The process for distributing according to claim 17, wherein the business transaction is report generation, settlement, or fund transfer.

19. The process for distributing according to claim 15, further including using an RF reader to establish the communication.

20. The process for distributing according to claim 19, wherein the RF communication is at an RFID frequency or a near field communication frequency.

21. The process for distributing according to claim 10, wherein the items are optical discs or electronic products.

22. The process for distributing according to claim 10, wherein the business transaction is a settlement transaction that comprises fund transfer.

23. The process for distributing according to claim 10, wherein the business transaction comprises automatic report generation.

24. A process for distributing products, comprising:
capturing authenticated deactivation events for each item of product deactivated;
capturing authenticated distributor event for each item of product that moves from one authorized distribution entity to another authorized distribution entity;
capturing authenticated activation event for each item of product that is activated; and
using the captured events to conduct a business transaction.

25. The process for distributing according to claim 24, further including the steps of:
capturing authenticated return events for each item of product that is returned to an authorized return entity; and
adjusting the business transaction according to the returned items.

26. The process for distributing according to claim 24, further including the steps of:
capturing authenticated kill events for each item of product that is permanently disabled by an authorized entity; and
adjusting the business transaction according to the disabled items.

27. The process for distributing according to claim 24, wherein the authenticated events are generated by embedded processors that are associated with the items communicating with a conditional access network.

28. The process for distributing according to claim 24, wherein a conditional access network captures the authenticated events.

29. The process for distributing according to claim 24, wherein the business transaction is conducted periodically.

30. The process for distributing according to claim 24, wherein the business transaction is conducted daily, weekly, monthly, or quarterly.

31. The process for distributing according to claim 24, wherein the business transaction is report generation, settlement, or fund transfer.

32. The process for distributing according to claim 24, wherein the items are optical discs or electronic products.
